(19) United States
(12) Patent Application Publication
(10) Pub. No.: US 2008/0004925 A1
(43) Pub. Date: Jan. 3, 2008

(54) MULTI-SITE PROJECT MANAGEMENT

(76) Inventors: Matthew J. Bangel, Poughkeepsie, NY (US); Andrew J. Garrett, Abbots Langley (GB); James A. Martin, Endicott, NY (US)

Correspondence Address: HOFFMAN, WARNICK & D'ALESSANDRO LLC, 75 STATE ST, 14TH FLOOR, ALBANY, NY, 12207, US

(21) Appl. No.: 11/427,536

(22) Filed: Jun. 29, 2006

(51) Int. Cl. G06F 17/50

(52) U.S. Cl. 705/7

(57) ABSTRACT

A solution for managing a multi-site project is provided. In particular, a set of configuration records, each of which defines a unique workflow activity, is used to generate a workflow for a site in the multi-site project. To this extent, the workflow includes an activity record that is created based on a configuration record that defines a corresponding workflow activity to be performed for the site. The workflow also can be generated based on one or more condition configuration records, each of which defines one or more conditions related to a workflow activity. Data fields and/or values for the activity record(s) can be obtained from project and/or site information in addition to the configuration record. In this manner, the invention provides a flexible, comprehensive solution for managing a multi-site project.

### FIELD OF THE INVENTION

The invention relates generally to project management, and more particularly, to a solution for managing workflows for sites in a multi-site project.

### BACKGROUND OF THE INVENTION

Frequently, a large-scale project will require that work be performed at multiple sites. Additionally, the sites often can be grouped with other similar sites that require the same work. For example, in order to upgrade an information technology (IT) infrastructure for a bank, work will need to be performed at each branch of the bank, remote automated teller machine (RATM) of the bank, office location of the bank, and the like. To this extent, the work performed at each RATM, branch, and office location may be similar. However, existing project management approaches do not exploit this attribute of multi-site projects in a flexible, configurable, and robust manner.

In view of the foregoing, a need exists to overcome one or more of the deficiencies in the related art.

### BRIEF SUMMARY OF THE INVENTION

The invention provides a solution for managing a multi-site project. In particular, a set of configuration records, each of which defines a unique workflow activity, is used to generate a workflow for a site in the multi-site project. To this extent, the workflow includes an activity record that is created based on a configuration record that defines a corresponding workflow activity to be performed for the site. The workflow also can be generated based on one or more condition configuration records, each of which defines one or more conditions related to a workflow activity. Data fields and/or values for the activity record(s) can be obtained from project and/or site information in addition to the configuration record. In this manner, the invention provides a flexible, comprehensive solution for managing a multi-site project.

A first aspect of the invention provides a method of managing a multi-site project, the method comprising: managing a set of configuration records, wherein each configuration record defines a unique workflow activity; and generating a workflow for a site in the multi-site project, wherein the generating includes creating an activity record based on a configuration record that defines a corresponding workflow activity.

A second aspect of the invention provides a system for managing a multi-site project, the system comprising: a system for managing a set of configuration records, wherein each configuration record defines a unique workflow activity; and a system for generating a workflow for a site in the multi-site project, wherein the generating includes creating an activity record based on a configuration record that defines a corresponding workflow activity.

A third aspect of the invention provides a computer program comprising program code stored on a computer-readable medium, which when executed, enables a computer system to implement a process for managing a multi-site project, the process comprising: managing a set of configuration records, wherein each configuration record defines a unique workflow activity; and generating a workflow for a site in the multi-site project, wherein the generating includes creating an activity record based on a configuration record that defines a corresponding workflow activity.

A fourth aspect of the invention provides computer software embodied in a propagated signal for managing a multi-site project, the computer software comprising instructions for causing a computer system to perform the following: manage a set of configuration records, wherein each configuration record defines a unique workflow activity; and generate a workflow for a site in the multi-site project, wherein the generating includes creating an activity record based on a configuration record that defines a corresponding workflow activity.

A fifth aspect of the invention provides a method of generating a system for managing a multi-site project, the method comprising: providing a computer system operable to: manage a set of configuration records, wherein each configuration record defines a unique workflow activity; and generate a workflow for a site in the multi-site project, wherein the generating includes creating an activity record based on a configuration record that defines a corresponding workflow activity.

A sixth aspect of the invention provides a business method for managing a multi-site project, the business method comprising managing a computer system that performs the process described herein; and receiving payment based on the managing.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a multi-site project according to an embodiment of the invention.

FIG. 2 shows an illustrative data flow diagram for the various modules of the project management program of FIG. 1 according to an embodiment of the invention.

FIG. 3 shows an illustrative user interface for managing a set of configuration records according to an embodiment of the invention.

FIG. 4 shows another illustrative user interface for managing a set of configuration records according to an embodiment of the invention.

FIG. 5 shows an illustrative activity configuration record according to an embodiment of the invention.

FIG. 6 shows an illustrative user interface for managing a set of site workflows according to an embodiment of the invention.

FIG. 7 shows another illustrative user interface for managing a set of site workflows according to an embodiment of the invention.

FIG. 8 shows an illustrative activity record according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for managing a multi-site project. In particular, a set of configuration records, each of which defines a unique workflow activity, is used to generate a workflow for a site in the multi-site project. To this extent, the workflow includes an activity record that is created based on a configuration record that defines a corresponding workflow activity to be performed for the site. The workflow also can be generated based on one or more condition configuration records, each of which defines one or more conditions related to a workflow activity. Data fields and/or values for the activity record(s) can be obtained from project and/or site information in addition to the configuration record. In this manner, the invention provides a flexible, comprehensive solution for managing a multi-site project. As used herein, unless otherwise noted, the term “set” means one or more (i.e., at least one) and the phrase “any solution” means any now known or later developed solution.

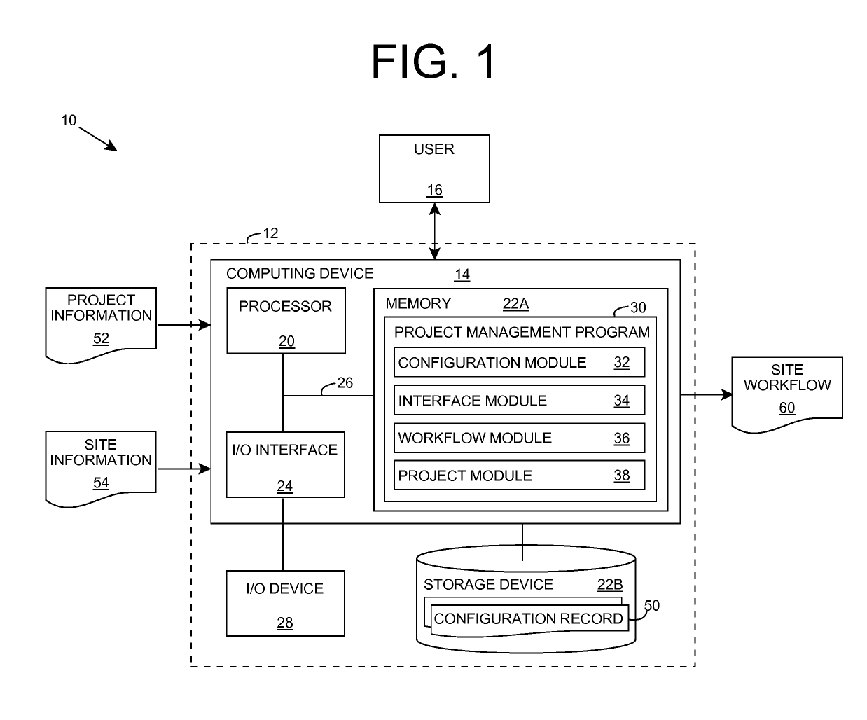

Turning to the drawings, FIG. 1 shows an illustrative environment 10 for managing a multi-site project according to an embodiment of the invention. To this extent, environment 10 includes a computer system 12 that can perform the process described herein in order to manage the multi-site project. In particular, computer system 12 is shown including a computing device 14 that comprises a project management program 30, which makes computing device 14 operable to manage the multi-site project by performing the process described herein. While generally described herein as a physical location, it is understood that the term “site” is inclusive of any type of locus, physical, abstract, or otherwise, for a project.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as project management program 30, which is stored in a storage system, such as memory 22A and/or storage device 22B. While executing program code, processor 20 can read and/or write data, such as a configuration record 50, to/from memory 22A, storage device 22B, and/or I/O interface 24. Bus 26 provides a communications link between each of the components in computing device 14. I/O device 28 can comprise any device that transfers information between a user 16 and computing device 14. To this extent, I/O device 28 can comprise a user I/O device to enable an individual user 16 to interact with computing device 14 and/or a communications device to enable a system user 16 to communicate with computing device 14 using any type of communications link.

In any event, computing device 14 can comprise any general purpose computing article of manufacture capable of executing program code installed thereon. However, it is understood that computing device 14 and project management program 30 are only representative of various possible equivalent computing devices that may perform the process described herein. To this extent, in other embodiments, the functionality provided by computing device 14 and project management program 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing the invention. For example, in one embodiment, computer system 12 comprises two or more computing devices that communicate over any type of communications link, such as a network, a shared memory, or the like, to perform the process described herein. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

As discussed herein, project management program 30 enables computer system 12 to manage a multi-site project. To this extent, project management program 30 is shown including a configuration module 32, an interface module 34, a workflow module 36, and a project module 38. Operation of each of these modules is discussed further herein. However, it is understood that some of the various modules shown in FIG. 1 can be implemented independently, combined, and/or stored in memory of one or more separate computing devices that are included in computer system 12. Further, it is understood that some of the modules and/or functionality may not be implemented, or additional modules and/or functionality may be included as part of computer system 12.

Regardless, the invention provides a solution for managing a multi-site project. In particular, project management program 30 can generate a workflow 60 for a site (site workflow) using a configuration record 50. Configuration module 32 manages a set of configuration records 50. Each configuration record 50 defines a unique workflow activity. A workflow activity can comprise any work that is required to be performed for a particular site in the project. To this extent, a workflow activity can comprise a set of processes that are to be performed for the site. The processes can be related by a common goal, and can include any combination of processes, including for example, the installation of new hardware/software, contacting an individual, ordering equipment, performing any of various services, and/or the like. Further, the workflow activity can define an order for performing the set of processes as well as a time line during which the processes are to be performed. However, it is understood that a workflow activity can include various additional data items.

Configuration module 32 can use any type of data store to store the set of configuration records 50. For example, configuration records 50 can be stored as one or more files, as one or more records in a database, and/or the like. Further, configuration module 32 can enable a user 16 to manage configuration records 50. To this extent, configuration module 32 can generate a user interface for display to user 16, which enables user 16 to specify one or more operations (e.g., add, delete, modify, view, etc.) to be performed on configuration record(s) 50. Similarly, configuration module 32 can define an Application Program Interface (API) or the like that enables user 16, which comprises another computer system, to specify various operations to be performed on configuration record(s) 50. In either case, configuration module 32 can perform the specified operation. To this extent, configuration module 32 can generate a copy of one or more stored configuration records 50 in a dynamic memory, perform the operation on the copy, and, upon receiving a request from user 16, update the stored configuration record(s) 50 with the modified copy in dynamic memory.

In any event, configuration record(s) 50 can be used to generate a workflow for a site (site workflow 60) in the multi-site project. Further, additional information, such as project information 52 and/or site information 54 can be used to generate site workflow 60. Project information 52 can comprise any type of information on the multi-site project, such as a customer, a manager, a customer contact, a project name, a target completion date, a project identifier, and/or the like. Similarly, site information 54 can comprise any type of information on a particular site in the multi-site project, such as a location, a site manager, a site customer contact, a site name, a site completion date, a site identifier, and/or the like. Regardless, project information 52 and site information 54 can be stored using any solution (e.g., one or more files, records, and/or the like).

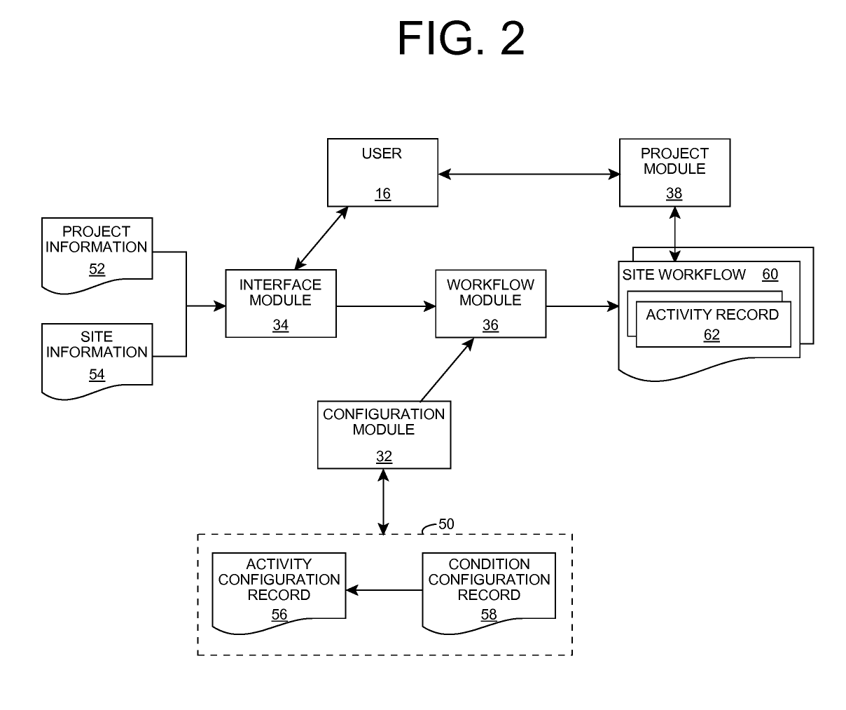

FIG. 2 shows an illustrative data flow diagram for the various modules of project management program 30 (FIG. 1) according to an embodiment of the invention. In this case, interface module 34 can obtain project information 52 and/or site information 54 from, for example, user 16. To this extent, user 16 can specify (e.g., provide, generate, modify, and/or the like) project information 52 and/or site information 54 using a user interface, API, and/or the like, which is generated and provided by interface module 34. Similarly, interface module 34 can receive a request from user 16 to generate a site workflow 60. In particular, the request can designate one or more desired workflow activities, project information 52, and/or site information 54 to be used in generating site workflow 60.

In response to the request, workflow module 36 can generate site workflow 60. To this extent, site workflow 60 can include a set of activity records 62. Each activity record 62 includes data for managing a corresponding workflow activity to be performed for the site. Workflow module 36 can create each activity record 62 based on a configuration record 60 that defines the corresponding workflow activity. To this extent, workflow module 36 can obtain a set of configuration records 50 that correspond to the requested set of workflow activities for the site. Workflow module 36 can use each configuration record 50 as a template for generating a corresponding activity record 62. In particular, workflow module 36 can use some or all of the data in configuration record 50 as data for activity record 62. Additionally, workflow module 36 can include additional data from project information 52 (e.g., project identifier, project end date, etc.) and/or site information 54 (e.g., site identifier, site end date, site contact, etc.). In any event, workflow module 36 can obtain data from configuration record 50, project information 52, and/or site information 54 to create each activity record 62. Further, some data may remain empty, to be filled in later by user 16. Still further, the data may comprise default values, which are editable by user 16.

In one embodiment, configuration record 50 includes an activity configuration record 56 and a set of related condition configuration records 58. Activity configuration record 56 can include various data for generating activity record 62. Each condition configuration record 58 can include data on one or more conditions for the workflow activity. A condition comprises some event, configuration, activity, process, and/or the like, which is related to the workflow activity defined in the related activity configuration record 56. In one embodiment, a condition can comprise a prerequisite condition, in which case the condition should be fulfilled prior to the completion of the workflow activity, or a condition can comprise a post-processing condition, in which the condition should be fulfilled after completion of the corresponding workflow activity.

Condition configuration record(s) 58 can be stored separately from activity configuration record(s) 56 and linked using any solution. To this extent, a condition configuration record 58 can be associated with a plurality of activity configuration records 56. Configuration module 32 can enable user 16 to manage the links using any solution (e.g., a user interface, an API, and/or the like). Further, one or more condition configuration records 58 may not be linked to any activity configuration records 56. To this extent, interface module 34 can receive a request to generate site workflow 60, in which one or more conditions are specified for a corresponding workflow activity designated in the request. In this case, workflow module 36 can obtain the activity configuration record 56 that corresponds to the workflow activity, and the set of condition configuration records 58 that correspond to the condition(s) and dynamically link the two for the particular site workflow 60. Additionally, configuration record 50 can define a set of default condition configuration records 58 for an activity configuration record 56, which user 16 can modify (e.g., add, delete, modify conditions) when requesting generation of site workflow 60.

In any event, workflow module 36 can generate an activity record 62 for site workflow 60 based on activity configuration record 56 and each condition configuration record 58 designated for the workflow activity. In one embodiment, workflow module 36 can schedule the activity record 62 based on the condition configuration record 58. Additionally, workflow module 36 can create an additional activity record 62 based on a condition configuration record 58. In either case, the activity record 62 can be scheduled based on the type of condition (e.g., prerequisite, post-processing, or the like). Alternatively, additional fields/data may be included in an activity record 62. Still further, site workflow 60 could include a condition record, which includes the data for the corresponding condition, and which is associated with one or more activity records 62.

Once site workflow 60 has been generated, project module 38 can enable user 16 to manage a process at the site using site workflow 60. In particular, project module 38 can enable user 16 to examine site workflow 60 to identify, which of a plurality of activities in a particular activity record 62 requires performance, which individual(s)/company(s) are responsible for performing an activity, a time frame for the activity, and/or the like. Additionally, project module 38 can enable user 16 to update activity record 62 with performance information for the corresponding workflow activity. In particular, project module 38 can enable user 16 to modify (e.g., add, delete, change) data values in the activity record 62 once an activity has been scheduled, completed, canceled, and/or the like. In one embodiment, project module 38 obtains a set of centrally stored condition configuration records 58 while managing an activity record 62, and adjusts the processing of the workflow activity accordingly. For example, a condition configuration record 58 may identify an individual that is to be notified when a particular workflow activity is canceled. It is understood that multiple users 16 can manage performance information for site workflow(s) 60. To this extent, project module 38 can limit the functionality and/or data provided for each user 16 based on a level of access for the user 16 using any solution.

Similarly, project module 38 can enable user 16 to manage a plurality of site workflows 60 for a plurality of sites in the multi-site project. In this case, project module 38 can generate a user interface that enables user 16 to evaluate performance information for the multi-site project. For example, the user interface can provide data on activities currently scheduled/being performed at each site, an indication of whether a site is on/behind/ahead of schedule, and/or the like. Further, the user interface(s) can enable user 16 to drill down to evaluate additional information on a particular site workflow 60, a particular activity record 62 for the site workflow, etc. In this manner, the invention provides a flexible, comprehensive solution for managing a multi-site project.

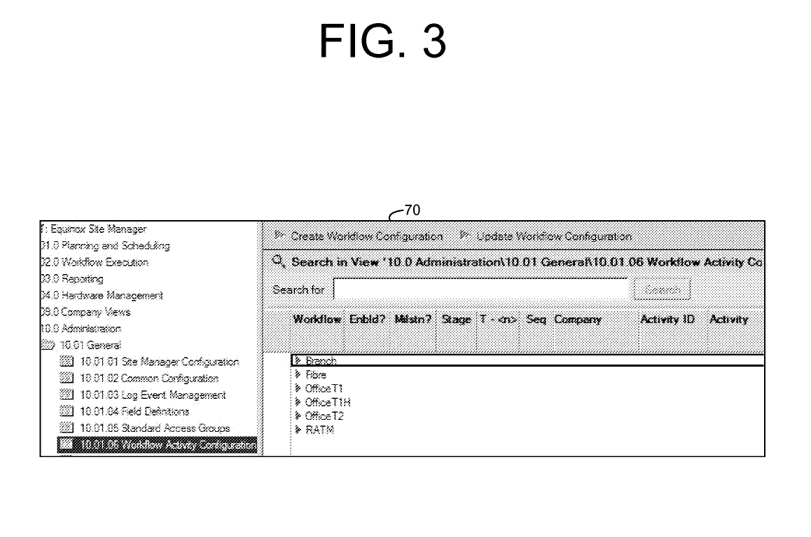

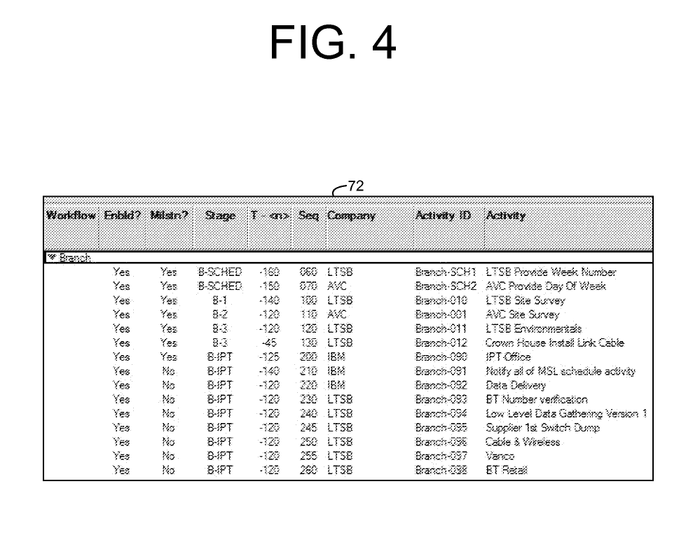

Additional features of the invention are further described with reference to an illustrative application, in which an upgrade of an Information Technology (IT) infrastructure for a bank is being managed. In this case, various locations of the bank will each require an upgrade. Based on the type of location, the activities required to perform the upgrade will differ. To this extent, FIGS. 3-4 show illustrative user interfaces 70, 72, respectively, which can be generated by configuration module 32 (FIG. 1), for enabling user 16 (FIG. 1) to manage a set of configuration records 50 (FIG. 1) according to an embodiment of the invention. As shown in FIG. 3, a configuration record 50 can be generated and provided for each type of site (e.g., branch, office, remote ATM, etc.). Each configuration record 50 can define one or more activities that are required to be performed at the corresponding site. To this extent, user interface 72 of FIG. 4 shows a detailed view of a branch configuration record 50 according to an embodiment of the invention. Branch configuration record 50 is shown including a plurality of activities, each of which requires performance to implement the IT infrastructure upgrade that a particular branch of the bank.

User interface 72 illustrates various data fields that can be included in configuration record 50 (FIG. 1) for each activity. To this extent, each activity can comprise an activity configuration record 56 (FIG. 2), which is included in configuration record 50. In any event, each activity can be enabled/disabled, comprise a milestone/non-milestone, be assigned a responsible company, have a corresponding activity identifier and activity description, etc. Further, each activity can comprise a corresponding stage at which is occurs, a sequence number for ordering the activities, as well as a targeted time at which the activity is to occur. In the latter case, the time can be expressed as a number of days prior to the targeted completion date for the site.

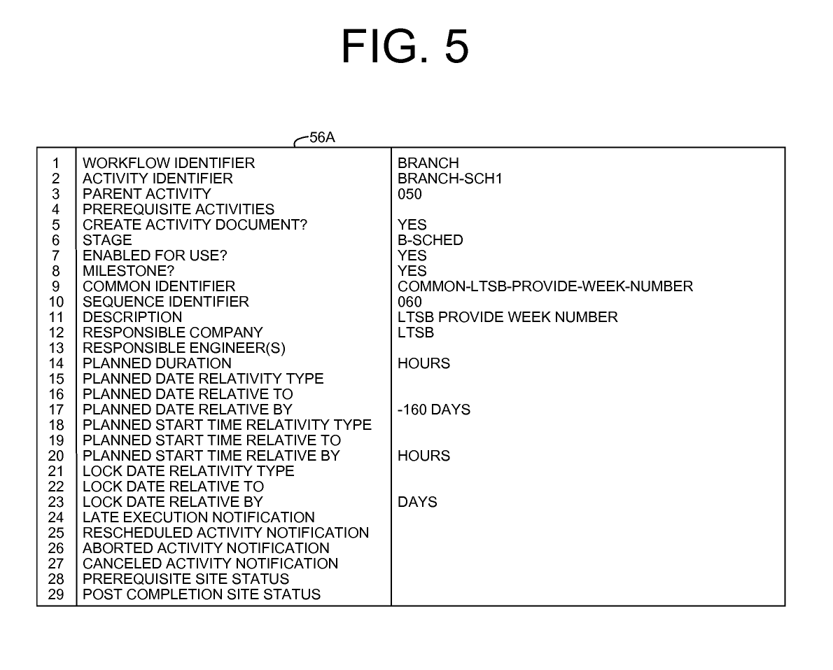

FIG. 5 shows an illustrative activity configuration record 56A according to an embodiment of the invention. In particular, activity configuration record 56A corresponds to the activity identifier “Branch-SCH1” shown in user interface 72 (FIG. 4). Regardless, activity configuration record 56A is shown including various data fields for the corresponding workflow activity. For example, activity configuration record 56A includes identifying information (e.g., workflow identifier, activity identifier, parent activity, etc.), information on responsible parties (e.g., company, engineer(s)), date/time information (e.g., duration, start date/time, lock date (date by which activity must be scheduled), etc.), notification information (e.g., reschedule, abort, cancel, etc.), and the like. It is understood that user interfaces 70, 72 and the corresponding data shown for activity configuration record 56A are only illustrative of numerous possible embodiments of the invention for managing configuration record(s) 50.

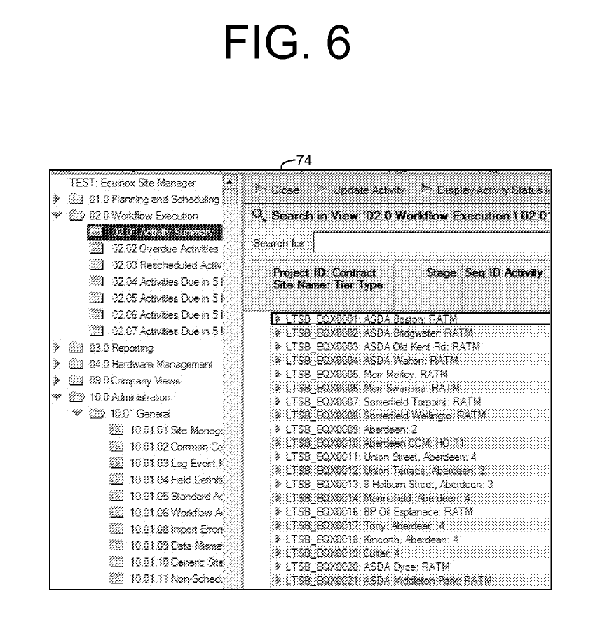

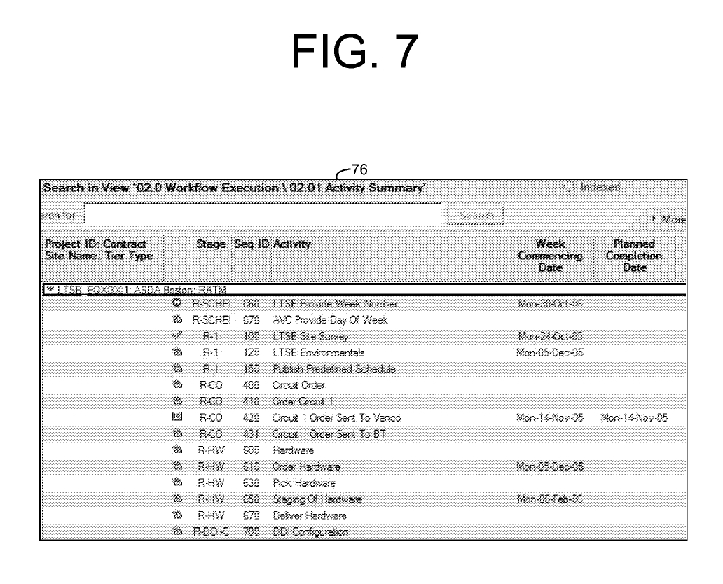

In any event, activity configuration record 56A can be used to create an activity record 62 (FIG. 2) for a site workflow 60 (FIG. 2). Subsequently, project module 38 can manage the set of site workflows 60. In particular, FIGS. 6-7 show illustrative user interfaces 74, 76, respectively, which can be generated by project module 38 (FIG. 1), for managing site workflow(s) 60 according to an embodiment of the invention. To this extent, interface 74 shown in FIG. 6 illustrates a tree view, which enables a user 16 (FIG. 1) to select various types of information to be displayed regarding the set of site workflows 60. As shown, interface 74 is displaying summary information for each site workflow 60 included in the multi-site project. However, user 16 can select to display information on overdue activities, rescheduled activities, activities due within a certain time period, etc. Further, in one embodiment, each activity configuration record 56A (FIG. 5) and corresponding activity record 62 (FIG. 2) includes a common identifier, which project module 38 can use to generate an interface for evaluating information on a particular activity for all sites throughout the project.

Interface 76 of FIG. 7 illustrates a more detailed view of a particular site workflow 60 (FIG. 2), which corresponds to the “LTSB_EQX0001” site workflow 60 shown in FIG. 6. As shown, interface 76 can display various data on each activity record 62 (FIG. 2) included in site workflow 60. For example, interface 76 is shown displaying scheduling information, such as stage, sequence identifier, week commencing date (e.g., Monday of week scheduled to begin), and planned completion date (e.g., date on which scheduled to complete). Further, interface 76 is shown including a graphical status indicator for each activity, e.g., canceled (warning graphic), complete (checkmark), not scheduled (finger with string), or scheduled (calendar). It is understood that these status indicators are only illustrative, and numerous alternatives are possible.

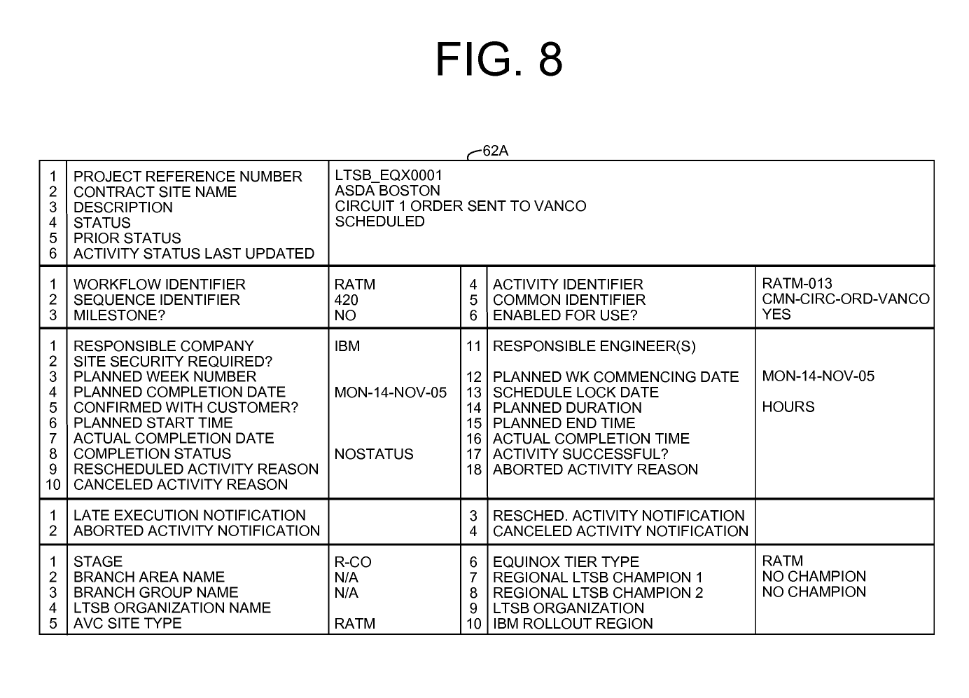

FIG. 8 shows an illustrative activity record 62A according to an embodiment of the invention. As shown, activity record 62A includes various fields/data that are obtained from a corresponding activity configuration record 56 (FIG. 2), such as workflow/sequence/common identifiers. Further, activity record 62A includes fields/data that are obtained from project information 52 (FIG. 2), such as a project reference number. Still further, activity record 62A includes fields/data that are obtained from site information 54 (FIG. 2), such as contract site name.

Additionally, activity record 62A can include data that is obtained from a combination of two or more of activity configuration record 56 (FIG. 2), project information 52 (FIG. 2), and site information 54 (FIG. 2). For example, project information 52 can include a planned completion date for the project, and site information 54 can include a relative completion date for the site (e.g., T-30). In this case, a planned completion date for the site can be determined from the planned completion date for the project. Similarly, activity configuration record 56 may include a relative completion/start date for the activity, which can be calculated based on the planned completion date for the site. In any event, as the corresponding workflow activity is performed, user 16 (FIG. 1) can update the information included in activity record 62A.

While shown and described herein as a method and system for managing a multi-site project, it is understood that the invention further provides various alternative embodiments. For example, in one embodiment, the invention provides a computer program stored on a computer-readable medium, which when executed, enables a computer system to manage a multi-site project. To this extent, the computer-readable medium includes program code, such as project management program 30 (FIG. 1), which implements the process described herein. It is understood that the term “computer-readable medium” comprises one or more of any type of tangible medium of expression (e.g., physical embodiment) of the program code. In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for managing a multi-site project. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that performs the process described herein on a subscription, advertising, and/or fee basis. That is, a service provider could offer to manage a multi-site project as described herein. In this case, the service provider can manage (e.g., create, maintain, support, etc.) a computer system, such as computer system 12 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that “program code” means any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as some or all of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a multi-site project, the method comprising:
managing a set of configuration records, wherein each configuration record defines a unique workflow activity; and
generating a workflow for a site in the multi-site project, wherein the generating includes creating an activity record based on a configuration record that defines a corresponding workflow activity.

2. The method of claim 1, wherein the generating further includes obtaining a condition configuration record for the corresponding workflow activity, wherein the condition configuration record defines at least one of: a prerequisite condition or a post-processing condition for the corresponding workflow activity.

3. The method of claim 2, wherein the generating further includes scheduling the activity record based on the condition configuration record.

4. The method of claim 1, further comprising managing a process at the site using the workflow, the process including a plurality of activities defined in the activity record.

5. The method of claim 4, wherein the managing includes updating the activity record with performance information.

6. The method of claim 1, further comprising managing a plurality of workflows for a plurality of sites in the multi-site project.

7. The method of claim 6, wherein the managing a plurality of workflows includes generating a user interface for enabling a user to evaluate performance information for the multi-site project.

8. The method of claim 1, wherein the creating an activity record is further based on at least one of: site information for the site or project information for the multi-site project.

9. A system for managing a multi-site project, the system comprising:
a system for managing a set of configuration records, wherein each configuration record defines a unique workflow activity; and
a system for generating a workflow for a site in the multi-site project, wherein the generating includes creating an activity record based on a configuration record that defines a corresponding workflow activity.

10. The system of claim 9, wherein the system for generating further includes a system for obtaining a condition configuration record for the corresponding workflow activity, wherein the condition configuration record defines at least one of: a prerequisite condition or a post-processing condition for the corresponding workflow activity.

11. The system of claim 10, wherein the system for generating further includes a system for scheduling the activity record based on the condition configuration record.

12. The system of claim 8, further comprising a system for managing a process at the site using the workflow, the process including a plurality of activities defined in the activity record.

13. The system of claim 12, wherein the system for managing includes a system for updating the activity record with performance information.

14. The system of claim 8, further comprising a system for managing a plurality of workflows for a plurality of sites in the multi-site project.

15. The system of claim 8, further comprising a system for obtaining at least one of: site information for the site or project information for the multi-site project, wherein the activity record is further based on the at least one of: site information for the site or project information for the multi-site project.

16. A computer program comprising program code stored on a computer-readable medium, which when executed, enables a computer system to implement a process for managing a multi-site project, the process comprising:
managing a set of configuration records, wherein each configuration record defines a unique workflow activity; and
generating a workflow for a site in the multi-site project, wherein the generating includes creating an activity record based on a configuration record that defines a corresponding workflow activity.

17. The computer program of claim 16, wherein the generating further includes obtaining a condition configuration record for the corresponding workflow activity, wherein the condition configuration record defines at least one of: a prerequisite condition or a post-processing condition for the corresponding workflow activity.

18. The computer program of claim 17, wherein the process further comprises scheduling the activity record based on the condition configuration record.

19. The computer program of claim 16, wherein the process further comprises managing a process at the site using the workflow, the process including a plurality of activities defined in the activity record.

20. The computer program of claim 16, wherein the process further comprises managing a plurality of workflows for a plurality of sites in the multi-site project.

21. The computer program of claim 16, wherein the creating an activity record is further based on at least one of: site information for the site or project information for the multi-site project.

22. A method of generating a system for managing a multi-site project, the method comprising:
providing a computer system operable to:
manage a set of configuration records, wherein each configuration record defines a unique workflow activity; and
generate a workflow for a site in the multi-site project, wherein the generating includes creating an activity record based on a configuration record that defines a corresponding workflow activity.
